(19) United States
(12) Patent Application Publication
(10) Pub. No.: US 2013/0273775 A1
(43) Pub. Date: Oct. 17, 2013

(54) FILTER PLUG

(71) Applicant: Ming-Fu CHIEN, Taipei (TW)

(72) Inventor: Ming-Fu CHIEN, Taipei (TW)

(21) Appl. No.: 13/554,512

(22) Filed: Jul. 20, 2012

(30) Foreign Application Priority Data
Apr. 17, 2012 (CN) 201220163941.3

(51) Int. Cl. H01R 13/7197

(52) U.S. Cl. 439/620.01

(57) ABSTRACT

A filter plug comprises a terminal holder with a recess body, a toroidal inductor and a cable. A plurality of conductive terminals are arranged on the recess body in a first direction thereof; a plurality of wire grippers are arranged on the recess body in a second direction thereof; and there is an angle between the first direction and the second direction. The toroidal inductor is arranged inside the recess body and comprises a magnetic ring with independent conductive coils wound thereon; two ends of the conductive coils are respectively connected to the conductive terminal and the wire gripper. The cable comprises a plurality of wires respectively connected to the wire grippers. The filter plug described above has filtering functions and is easy to assemble and can save space effectively.

### BACKGROUND OF THE INVENTION

1. Field of the Invention

The present invention relates to a power plug, and more particularly to a filter plug.

2. Description of the Prior Art

Alternating Current (AC) power supplied for daily life and industry is transmitted via connection between a plug and an outlet to electrical equipment. Conventional power plugs without filtering functions of anti-noise and anti-electromagnetic interference may easily cause early damage or high failure rate to electronic devices due to frequently pulse current. As to power plugs with filtering functions, unstable structure caused by insufficient protection over rectifier devices or by structure defect may lead to low yield. For another example as shown in FIG. 9, inappropriate design for the product structure (excessive H) is inconvenient for users.

### SUMMARY OF THE INVENTION

The present invention is directed to a filter plug, wherein by arranging conductive terminals and wire grippers with an angle, it allows easy assembly and saves space effectively.

According to an embodiment of the present invention, a filter plug comprises: a terminal holder comprising a recess body, a first holding portion and a second holding portion, wherein a plurality of conductive terminals are arranged on the first holding portion in a first direction of the recess body; a plurality of wire grippers are arranged on the second holding portion in a second direction of the recess body; a toroidal inductor is arranged inside the recess body, comprising a magnetic ring with a first conductive coil and a second conductive coil wound thereon, wherein two ends of the first conductive coil and the second conductive coil are respectively connected to a conductive terminal and a wire gripper; and a cable with a plurality of wires therein, wherein any wire is electrically connected to any wire gripper.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1, FIG. 2, FIG. 3A, FIG. 3B and FIG. 4A are schematic diagrams illustrating assembling the filter plug according to an embodiment of the present invention;

FIG. 4B is a cross section view of the section AA;

FIG. 5, FIG. 6A, FIG. 6B, and FIG. 6C are schematic diagrams illustrating the structure of the filter plug according to different embodiments of the present invention;

FIG. 7A, FIG. 7B, and FIG. 7C, are schematic diagrams illustrating the filter plug according to an embodiment of the present invention;

FIG. 8A, FIG. 8B, FIG. 8C, and FIG. 8D are schematic diagrams illustrating the structure of the filter plug according to different embodiments of the present invention; and

FIG. 9 is a schematic diagram illustrating the prior art structure of the filter plug.

### DESCRIPTION OF THE PREFERRED EMBODIMENT

The detail description is provided below and the preferred embodiments described are only for the purpose of description rather than for limiting the present invention.

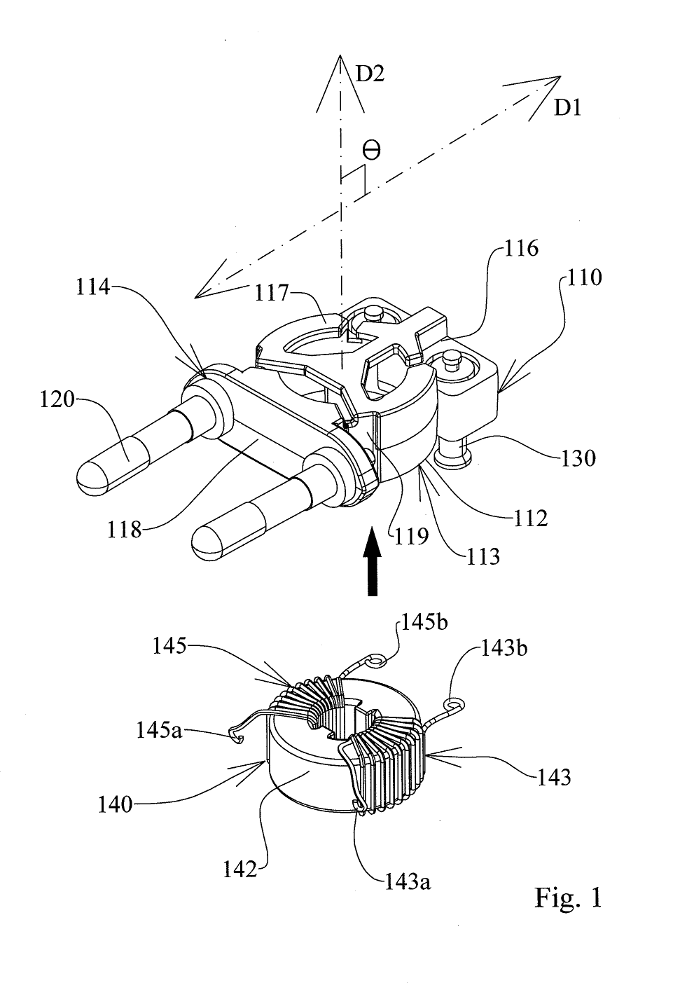

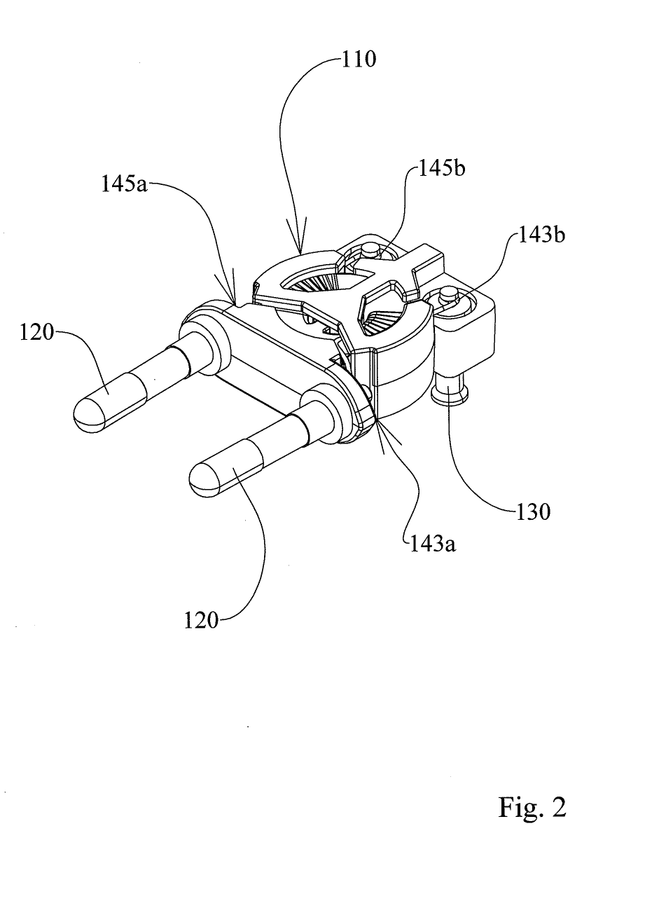

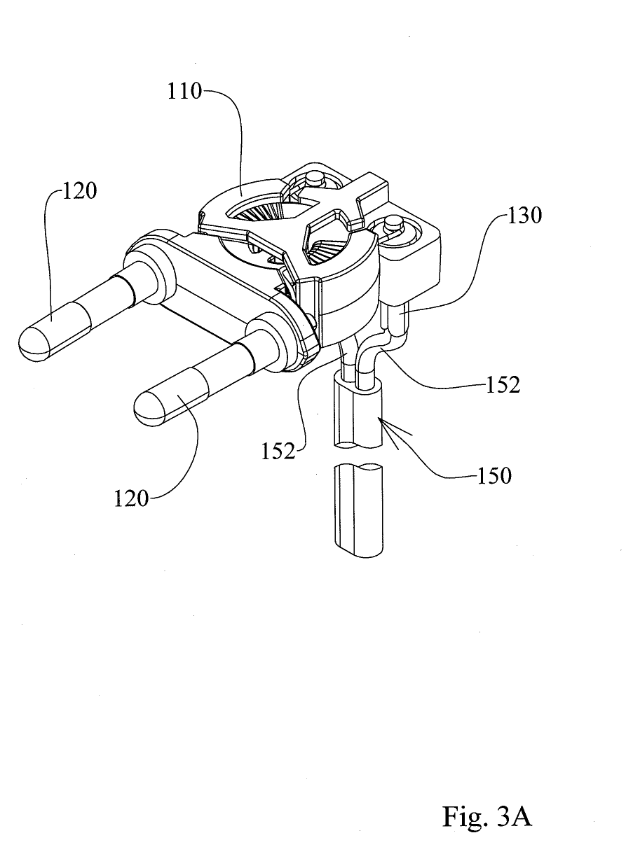

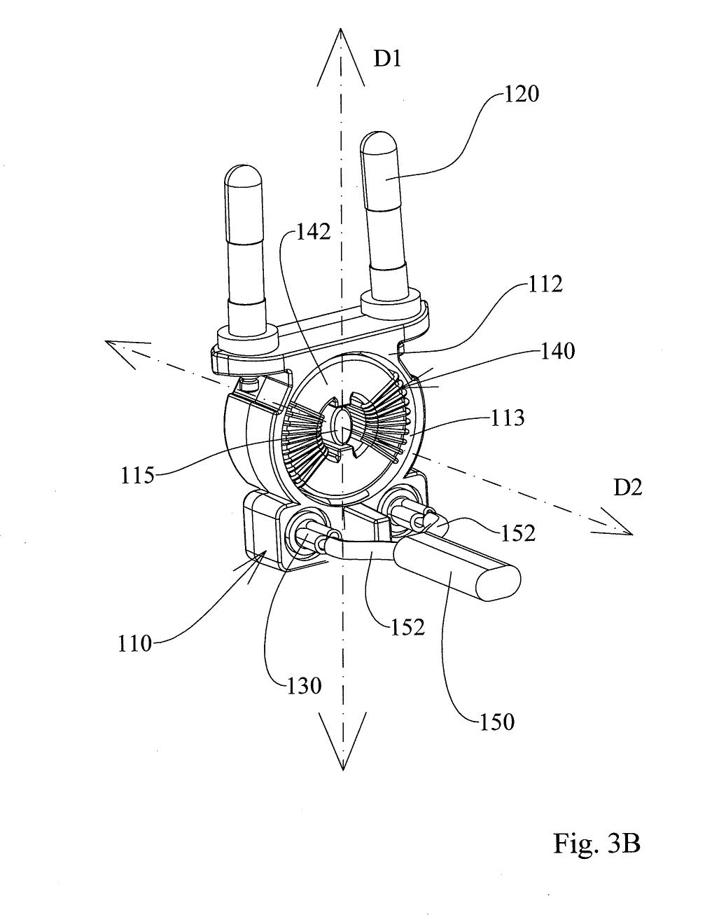

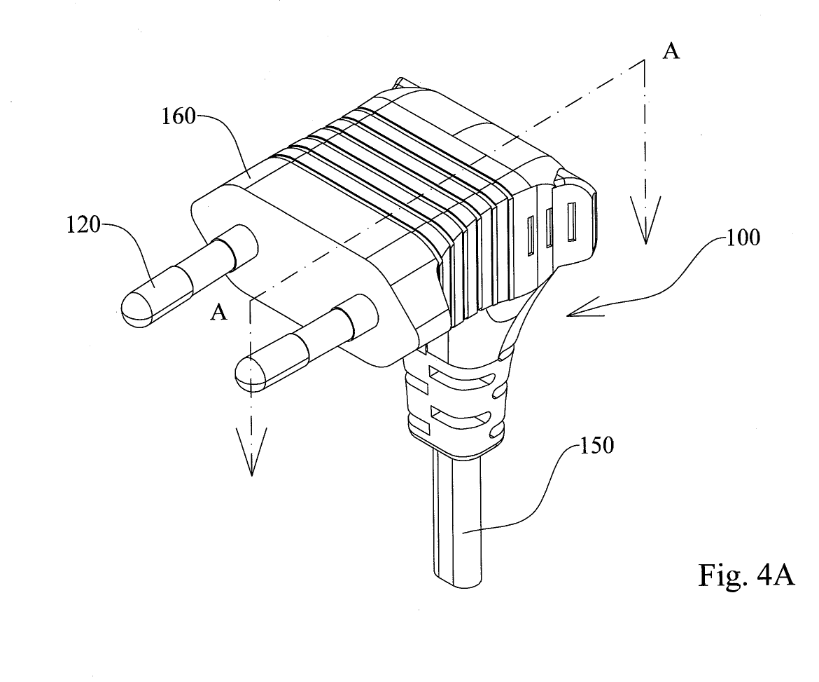

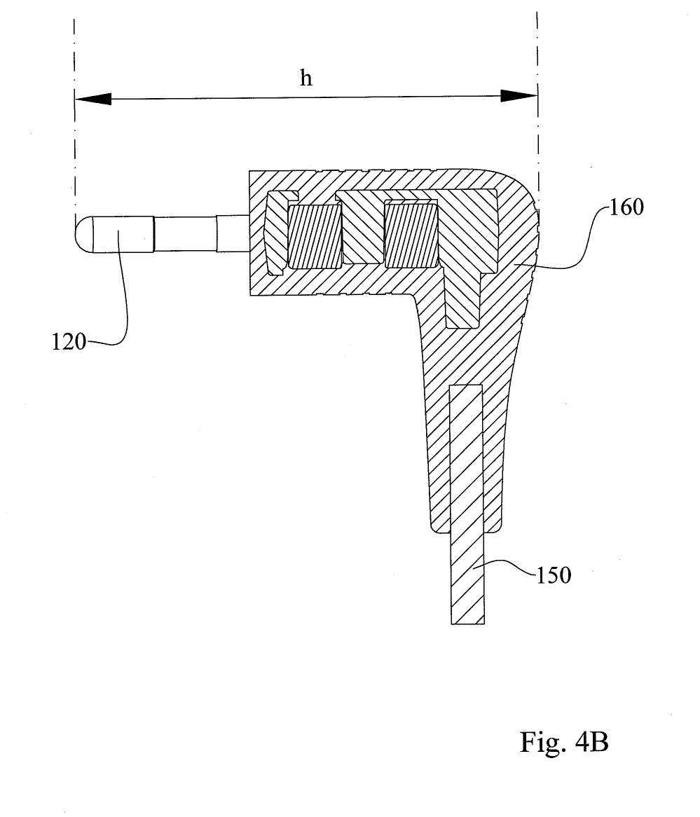

FIG. 1, FIG. 2, FIG. 3A, FIG. 3B and FIG. 4A are schematic diagrams illustrating assembling the filter plug according to an embodiment of the present invention. Firstly referring to FIG. 1 and FIG. 3A, in an embodiment, the filter plug comprises a terminal holder 110, a toroidal inductor 140 and a cable 150. The structure and assembling steps are described in detail below. Referring to FIG. 1, the terminal holder 110 comprises a recess body 112, a first holding portion 114, and the second holding portion 116, wherein a plurality of conductive terminals 120 are arranged on the first holding portion 114 in a first direction D1 of the recess body 112; conductive terminals 120 form external contact points of the filter plug. In this embodiment, the recess body 112 has a plate component 118 arranged on a side 119 thereof and the first holding portion 114 is arranged on the plate component 118. Besides, a plurality of wire grippers 130 are arranged on the second holding portion 116 of the recess body 112 in a second direction D2 of the recess body 112, wherein the wire grippers 130 are internal connection terminals of the filter plug. As shown in FIG. 1, there is an angle θ formed between the first direction D1 and the second direction D2, in an embodiment, the first direction D1 is substantially parallel to a bottom 117 of the recess body 112 and the second direction D2 is substantially vertical to the bottom 117 of the recess body 112, wherein the angle θ between the first direction D1 and the second direction D2 is properly 90 degrees and makes the filter plug L-shaped.

Referring to FIG. 1, an opening 113 of the recess body 112 is arranged in the second direction D2 and the toroidal inductor 140 is arranged inside the recess body 112 in the second direction D2, wherein the toroidal inductor 140 comprises a magnetic ring 142 and a first conductive coil 143 and a second conductive coil 145 wound thereon. In an embodiment, the first conductive coil 143 and the second conductive coil 145 are wound in opposite directions and are independent conductive coils with the same number of turns. Two ends of the first conductive coil 143 and the second conductive coil 145 are respectively connected to one of the conductive terminals 120 and one of the wire grippers 130, as shown in FIG. 2. After that, referring to FIG. 1 and FIG. 2, one end 143a of the first conductive coil 143 is connected to one of the conductive terminals 120 and the other end 143b is connected to one of the wire grippers 130; and one end 145a of the second conductive coil 145 is connected to one of the conductive terminals 120 and the other end 145b is connected to one of the wire grippers 130. In an embodiment, outer surface of the first conductive coil 143 and the second conductive coil 145 is electrically insulated and surface of the magnetic ring 142 is also covered by insulated materials.

Referring to FIGS. 3A and 3B, FIG. 3A is a schematic diagram of the structure of the filter plug in 3A viewed from another angle. The cable 150 has a plurality of wires 152 and one of them is connected to one of the wire grippers 130 to form electrical connection inside the structure. In an embodiment, as shown in FIG. 3B, the recess body 112 comprises a positioning pillar 115 protruding from the central hollow part of the magnetic ring 142 to position the toroidal inductor 140 in the terminal holder 110.

After assembling the cable 150, it is covered by a insulated plastic shell 160 while the conductive terminal 120 and cable 150 are exposed to form the filter plug 100 as shown in FIG. 4A, wherein the filter plug 100 appears 90 degrees bend as L-shaped shown in FIG. 4B (FIG. 4B is a cross section view of AA section from FIG. 4A). The filter plug 100 according to an embodiment of the present invention appears L-shaped and can reduce dimension of products and conforms to security regulations of many countries. In addition, the filter plug 100 according to an embodiment of the present invention can reduce plug height h (as shown in FIG. 4B) to prevent power failure of electrical devices, where the power failure is because the height h of the plug structure is too long that users may unexpectedly touch it and unplug electrical devices. Thus, the filter plug of the present invention is more convenient and safe for use.

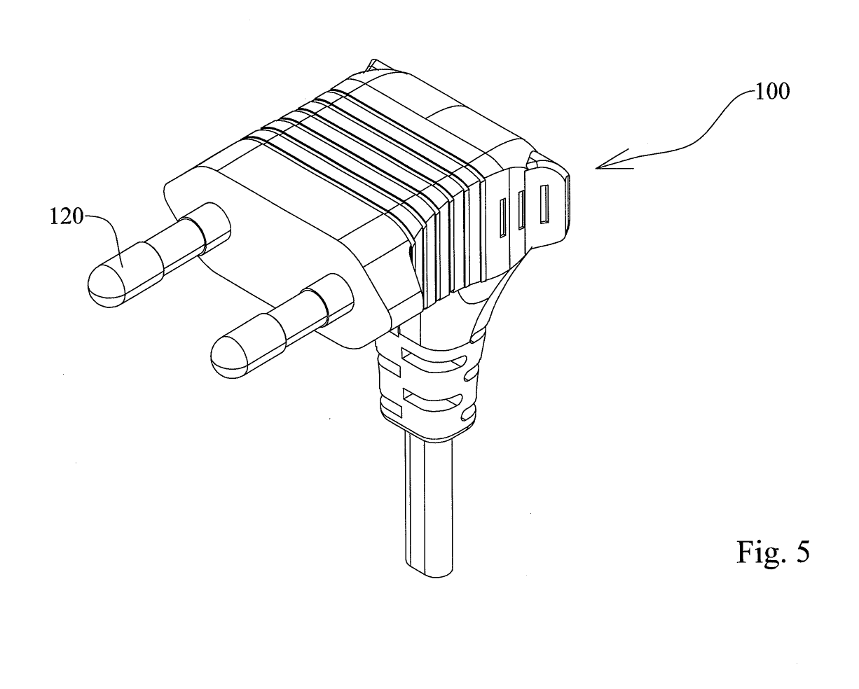

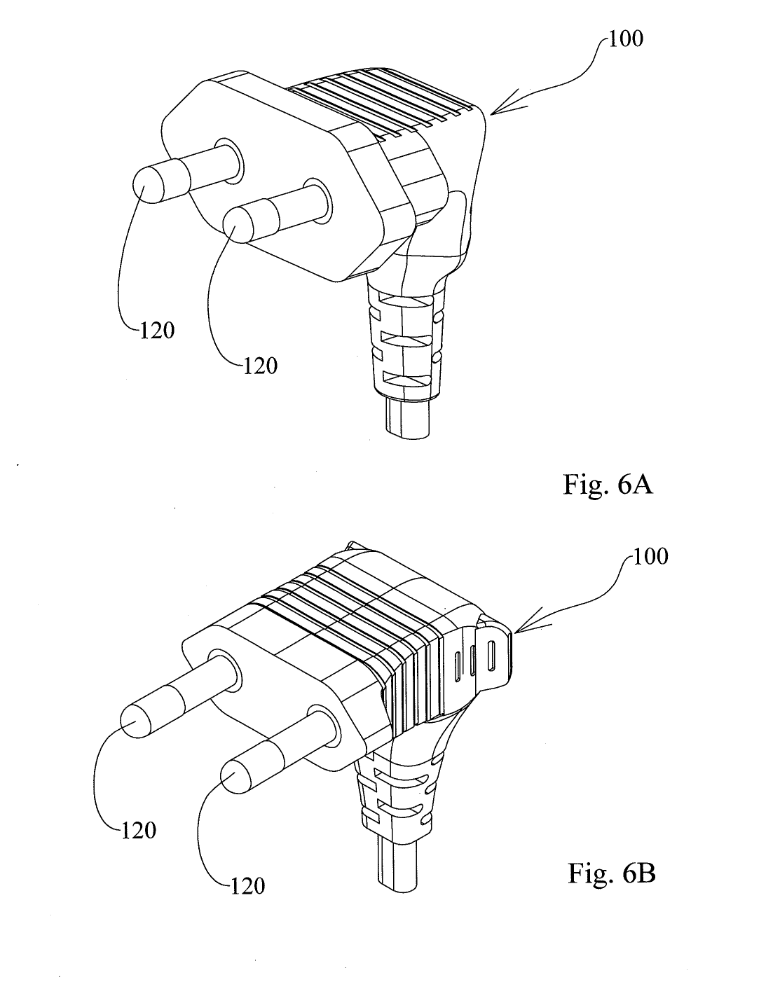

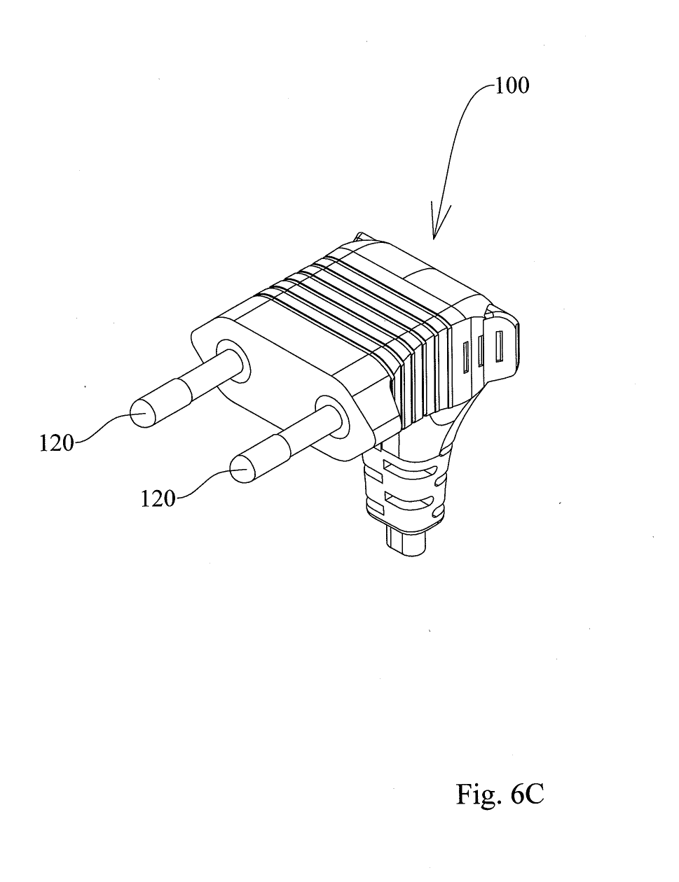

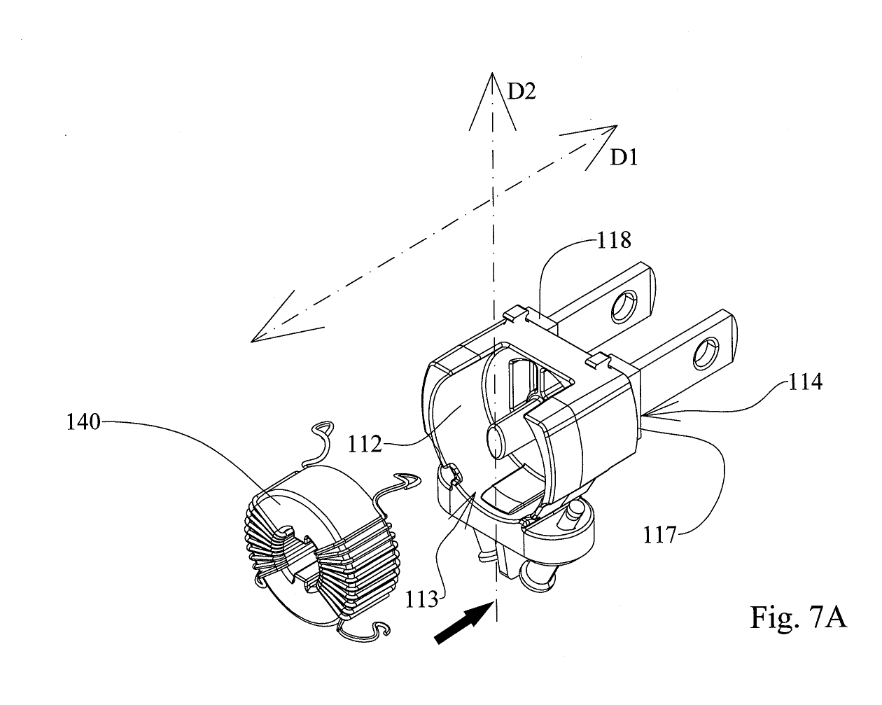

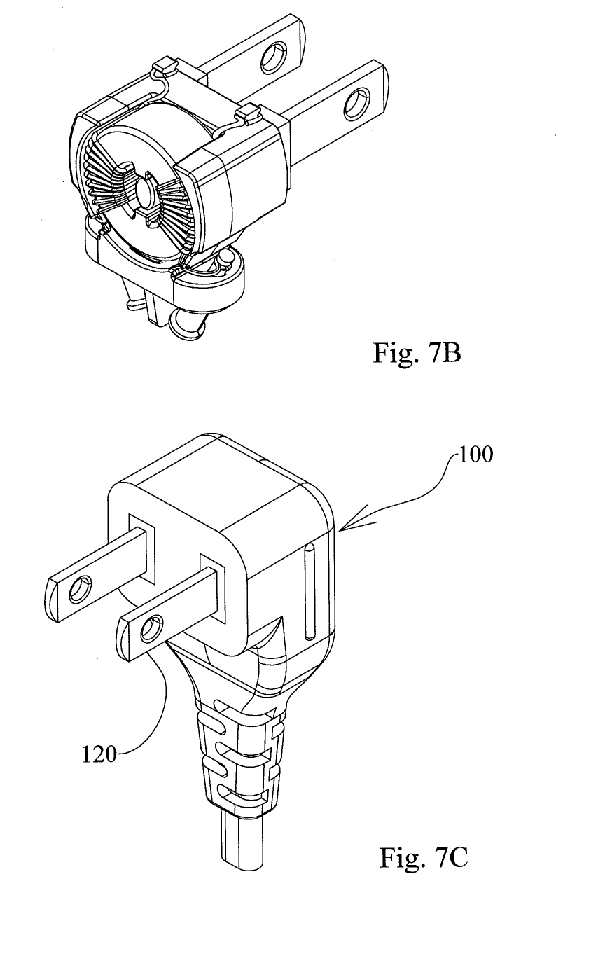

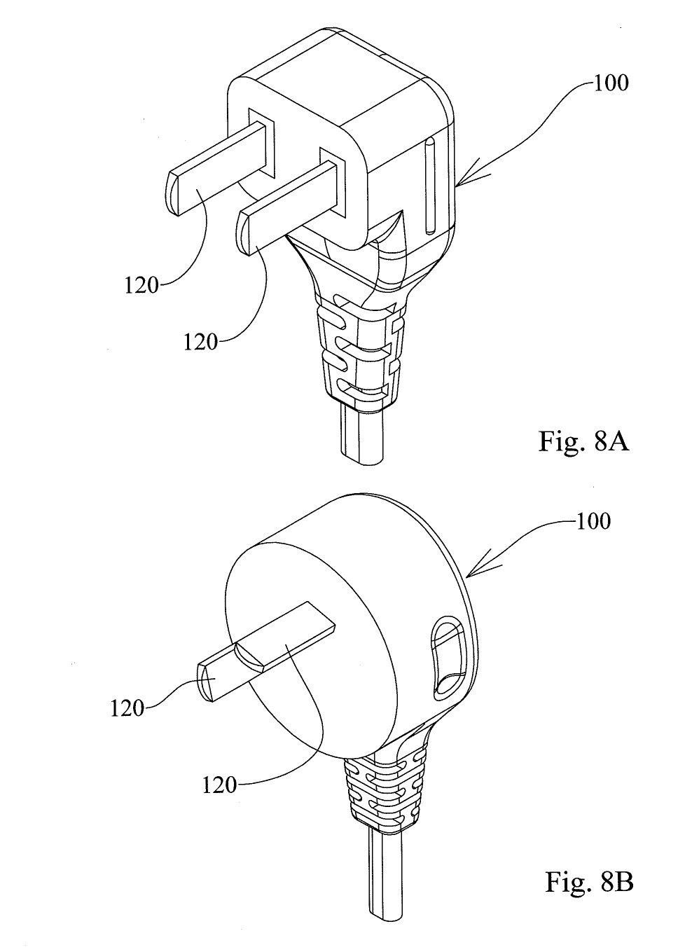

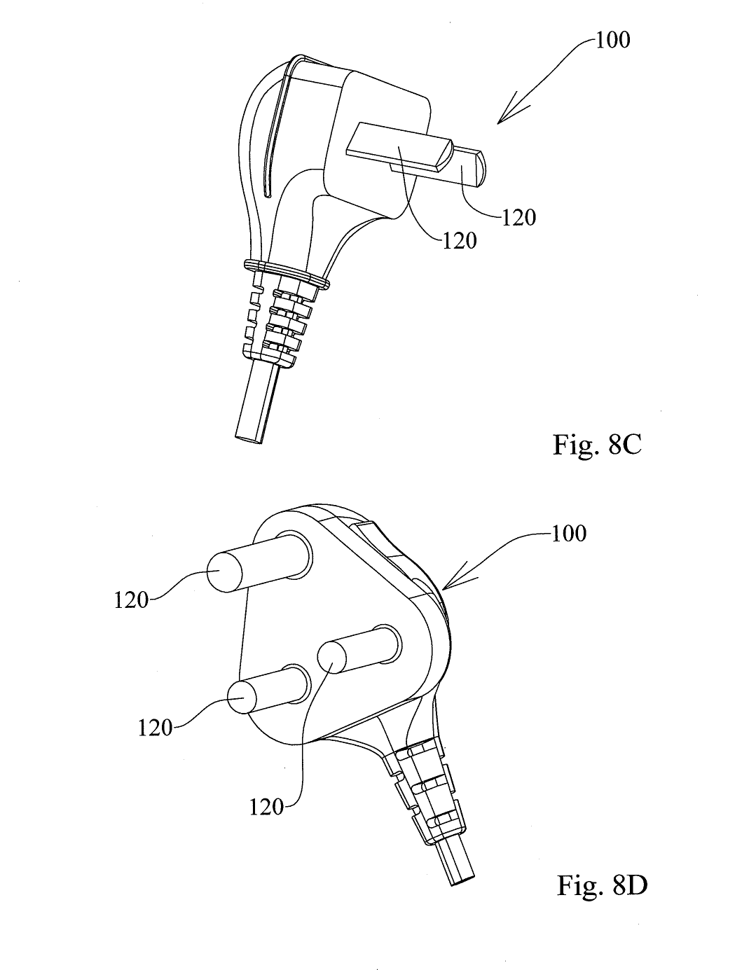

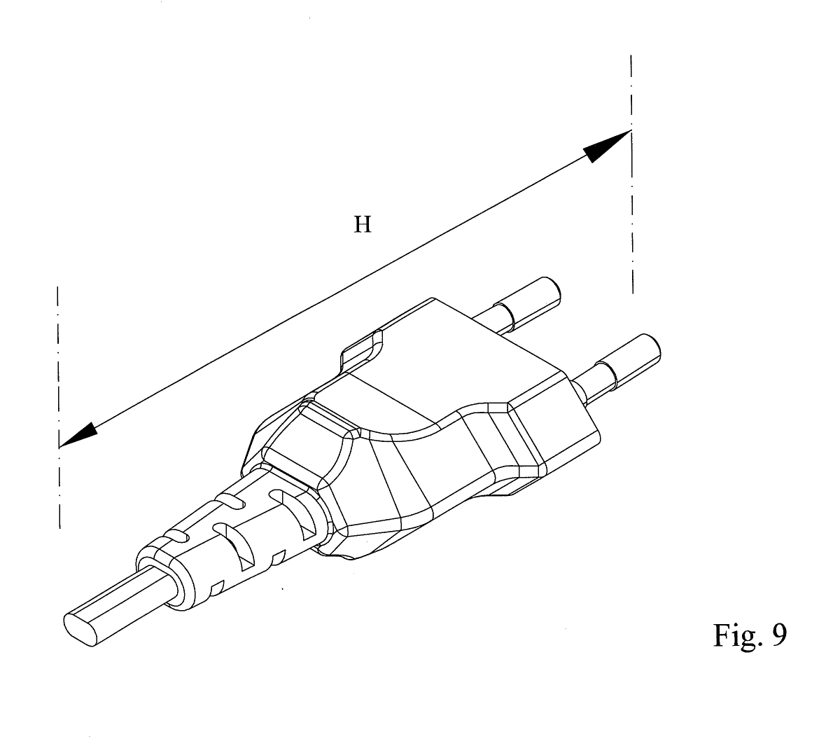

It also could be understood that the shell shape shown in FIG. 4A is merely an embodiment, wherein position arrangement of the conductive terminals 120 can conform to one of EU regulations, Israel regulations, Russian regulations, or Korean regulations (as shown in FIG. 5), or Indian regulations (as shown in FIGS. 6A and 6B) and Brazil regulations (as shown in FIG. 6C. The characteristic structure of the present invention also can be applied to other countries with different security regulations such as China, US, Canada, Australia and so on. In an embodiment as shown in FIG. 7A, FIGS. 7B and 7C, the difference from the last embodiment is the opening 113 of the recess body 112 is arranged in the first direction D1 and the toroidal inductor 140 is arranged in the recess body 112 in the first direction D1. Besides, the plate component 118 of the recess body 112 is arranged on the bottom 117 and the first holding portion 114 is arranged on the plate component 118. After assembling all the components, the structure is shown in FIG. 7B and the packaged structure is shown in FIG. 7C (the conductive terminals 120 conforms to one of US regulations or Taiwan regulations). In order to conform to different security regulations of different countries, different appearance of the filter plug 100 after being packaged, different structures and position arrangement of the conductive terminal 120 are designed as shown in FIG. 8A (the conductive terminal 120 conforms to China regulations), FIG. 8B (Australia regulations), FIG. 8C (Argentina regulations) and FIG. 8D (South Africa regulations).

According to description mentioned above, one characteristic of the present invention is to incorporate rectifier devices as inductor coil into internal connection line of the power plug. When electrical devices are connected to power, whether the negative effects caused by electricity fluctuation generated from power supply network or from electrical load via local area network, or caused by high impedance and magnetic flux generated from common mode current formed in AC line, these negative effects can be neutralized or eased in the magnetic ring of the toroidal inductor. By this way, noise interference and electromagnetic interference can be prevented to prolong the useful life of electrical equipment. Besides, design of the present invention makes assembly easier and promotes yield rate.

In conclusion, the present invention proposes a filter plug, wherein by arranging the conductive terminal and the wire gripper with an angle, it makes assembly easy and saves space effectively.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A filter plug, comprising:
a terminal holder comprising a recess body, a first holding portion and a second holding portion, wherein:
a plurality of conductive terminals are arranged on the first holding portion of the recess body in a first direction of the recess body;
a plurality of wire grippers are arranged on the second holding portion in a second direction of the recess body; and
an angle between the first direction and the second direction;
a toroidal inductor arranged inside the recess body, comprising a magnetic ring with a first conductive coil and a second conductive coil wound thereon, wherein two ends of the first conductive coil and the second conductive coil are respectively connected to one of the conductive terminals and the wire grippers; and
a cable with a plurality of wires, wherein one of the wires is electrically connected to one of the wire grippers.

2. The filter plug according to claim 1, wherein the winding directions of the first conductive coil and the second conductive coil are opposite.

3. The filter plug according to claim 1, wherein the outer surface of the first conductive coil and the second conductive coil are electrically insulated.

4. The filter plug according to claim 1, wherein the angle is 90 degrees to makes the filter plug L-shaped.

5. The filter plug according to claim 1, wherein the recess body comprises a positioning pillar protruding from the central hollow part of the magnetic ring.

6. The filter plug according to claim 1, wherein an insulated plastic shell covers the terminal holder and the toroidal inductor while the conductive terminals and the cable are exposed.

7. The filter plug according to claim 1, wherein an opening of the recess body faces toward the second direction.

8. The filter plug according to claim 7, wherein the recess body comprises a plate component arranged on a side thereof and the first holding portion is arranged on the plate component.

9. The filter plug according to claim 8, wherein position arrangement of the conductive terminals conforms to one of EU regulations, Korean regulations, Israel regulations, Russian regulations, Indian regulations and Brazil regulations.

10. The filter plug according to claim 1, wherein the opening of the recess body faces toward the first direction.

11. The filter plug according to claim 10, wherein the recess body comprises a plate component arranged on a bottom thereof and the first holding portion is arranged on the plate component.

12. The filter plug according to claim 11, wherein position arrangement of the conductive terminals conforms to one of US regulations, Taiwan regulations, China regulations, Australia regulations, South Africa regulations and Argentina regulations.
